(19) United States
(12) Patent Application Publication
(10) Pub. No.: US 2025/0028173 A1
(43) Pub. Date: Jan. 23, 2025

(54) TRANSPARENT COVER WINDOW FOR USE IN A NEAR INFRARED SENSING DEVICE

(71) Applicant: Google LLC, Mountain View, CA (US)

(72) Inventors: Saeid Rezaei, Waterloo (CA); Daniel Corbalan, Forest Hills, NY (US); Andrew Logan, Waterloo (CA); Jiwon Yang, Toronto (CA); Han Zhang, Shrewsbury, MA (US)

(21) Appl. No.: 18/353,590

(22) Filed: Jul. 17, 2023

(51) Int. Cl. G02B 27/01; G02B 1/11; G02B 1/14

(52) U.S. Cl. CPC G02B 27/0172; G02B 1/11; G02B 1/14; G02B 2027/0178

(57) ABSTRACT

A cover is described for use in protecting near infrared sensors mounted to an augmented reality headset. Manufacturing the cover includes a polycarbonate injection molding process followed by a multi-coating deposition process. Contours of the sensor apparatus can be masked prior to the deposition to improve yield.

### FIELD OF THE DISCLOSURE

The present disclosure relates to a user interface for an augmented reality (AR) or virtual reality (VR) headset.

### BACKGROUND

Augmented reality (AR) technology overlays digital content onto a real-world environment to provide an immersive experience for a user. Head-mounted wearable devices for AR/VR may include, for example, ear buds and head-mounted eyewear (e.g., headsets) such as smart glasses or goggles. Cameras, sensors, and inertial measurement units (IMUs) can be disposed on the headset, and images can be projected onto a lens of the headset, providing a heads-up display (HUD). Headsets and other wearable computing devices may include various types of electronic components for computation and both long-range and short-range radio frequency (RF) wireless communication.

### SUMMARY

Image sensors mounted on AR glasses next to a user's eye are made of plastic to satisfy safety concerns. However, glass sensors offer better optical characteristics. Plastic sensors and sensor covers are also difficult to manufacture using an injection molding process. To transmit near infrared (NIR) wavelengths, a thin sensor is needed, and various coatings, such as anti-reflective coatings, are applied. However, applying a thick coating to a thin molded plastic can result in poor adhesion and stress. Such challenges are addressed below.

In some aspects, the techniques described herein relate to a method, including: forming a molded plastic substrate having a film-in-mold layer on an internal surface thereof; and forming a stack of coatings on a portion of an external surface of the molded plastic substrate, the stack of coatings including at least one of a hard coating, an anti-reflective (AR) coating, or an anti-smudge (AS) coating.

In some aspects, the techniques described herein relate to an apparatus, including: a molded plastic substrate having a first surface and a second surface; a molding film attached to the first surface of the molded plastic substrate; and a stack of coatings formed on the second surface, the stack of coatings including: a hard coating in contact with the second surface of the molded plastic substrate; an AR coating in contact with the hard coating; and an AS coating in contact with the AR coating.

In some aspects, the techniques described herein relate to an apparatus including: a lens; a frame surrounding the lens; a light sensor mounted to the frame; a multi-layer cover over the light sensor; and a user-controlled switch that activates the multi-layer cover.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a frontal view of a pair of smart glasses, according to a possible implementation of the present disclosure.

FIG. 2 is a cross-sectional view of a transparent cover window, according to a possible implementation of the present disclosure.

FIG. 3A is a perspective view of a transparent cover window, according to a possible implementation of the present disclosure.

FIG. 3B is a perspective view of an apparatus underlying the transparent cover window, according to a possible implementation of the present disclosure.

FIG. 4 is a flow chart showing steps in a method of manufacturing a transparent cover window 200, according to a possible implementation of the present disclosure.

FIG. 5 is a system block diagram of a computer system for implementing the neural network model according to a possible implementation of the present disclosure.

The components in the drawings are not necessarily to scale relative to each other. Like reference numerals designate corresponding parts throughout the several views.

### DETAILED DESCRIPTION

An AR/VR headset may incorporate a near infrared (NIR) sensor for detecting energy, e.g., light or heat energy, in the near infrared portion of the electromagnetic spectrum. Such sensors may provide sensory information relating to the operation of one or more cameras located on, or associated with, the headset. The AR/VR headset can be in the form of, for example, AR glasses. In some implementations, the camera(s) can be located on an arm of the glasses, or at a temple of the frame of the glasses, where the arm connects to the front portion of the frame by a hinge. The NIR sensor can support operation of, for example, a night vision camera, a hand-tracking camera, an eye-tracking camera that monitors the user's eye motion, or a world-facing camera designed to capture scenes within the user's field of view.

In some implementations, it is desirable for the NIR sensor to be equipped with a cover having an external surface that can be accessed by the user. The cover can protect internal components, e.g., the various camera lenses and associated electronic components, when the NIR sensor is not in use. Design of the cover can be challenging, to ensure that it satisfies various performance criteria and results in sufficient manufacturing yield. Mounting the sensor cover onto the frame of the glasses also poses a challenge. Design and manufacturing considerations, and solutions to address these challenges, are described below.

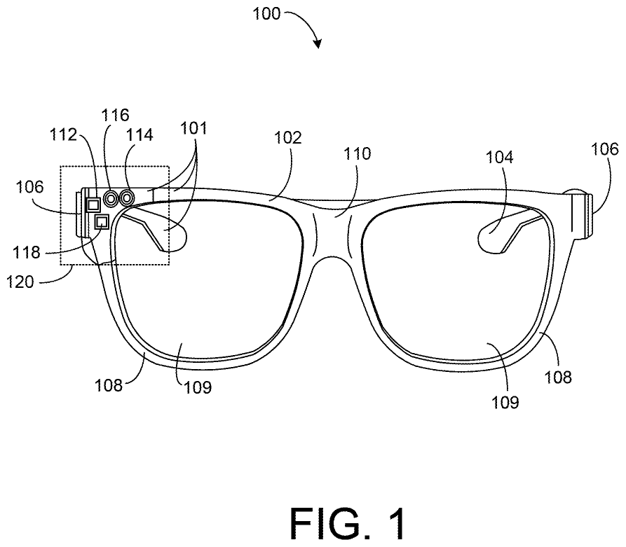

FIG. 1 is a front view of a head-mounted wearable display 100 in the form of smart glasses, or VR/AR glasses. In some implementations, the head-mounted wearable display 100 can be in the form of VR/AR goggles or another alternative style headset. In some implementations, the head-mounted wearable display 100 can include at least one of display capability, touch sensing, imaging capability, eye/gaze tracking capability, sound amplification capability, computing/processing capability, and RF communications capability.

The example head-mounted wearable display 100 as shown in FIG. 1 in the form of eyewear, e.g., smart glasses, includes a frame 101. The frame 101 includes a front frame portion 102, and a pair of arm portions 104 rotatably coupled to the front frame portion 102 by respective hinges 106. The front frame portion 102 includes rim portions 108 surrounding respective optical elements in the form of lenses 109, with a bridge portion 110 connecting the rim portions 108. The arm portions 104 are coupled, for example, pivotably or rotatably coupled, to the front frame portion 102 at peripheral portions of the respective rim portions 108. In some examples, the lenses 109 are corrective/prescription lenses. In some examples, the lenses 109 include an optical material such as glass and/or plastic optical elements that do not necessarily incorporate corrective/prescription parameters. In some implementations, the frame 101 is a rigid frame that can include, for example, a metal, a plastic material, a nylon material, or a carbon fiber material, or combinations thereof.

In some examples, the head-mounted wearable display 100 includes a display device (not shown) located on an inside surface of one of the arm portions 104. The display device can output visual content to inside surfaces of the lenses 109, so that the visual content is visible to the user as a heads-up display. In some implementations, display devices may be provided in each of the two arm portions 104 to provide for binocular output of content. In some implementations, waveguide optics may be used to depict content on the display device. In some implementations, the display device can include an organic light emitting diode (OLED) display configured to reproduce an image. The optic design of the lenses 109 may allow a user to see both physical items in the world, for example, through the lenses 109, next to content (for example, digital images, user interface elements, virtual content, and the like) output by the display device, for an augmented reality experience.

In some examples, the head-mounted wearable display 100 includes one or more electronic components such as, for example, a control system 112, a sensing system 114, and one or more image sensors 116, e.g., one or more cameras, and a battery 118. The electronic components can be housed in the frame 101 of the head-mounted wearable display 100. As shown in FIG. 1, the electronic components are located in a temple area 120 of the front frame portion 102. Alternatively, some of the electronic components, for example, the control system 112 and/or the battery 118, can be housed in other parts of the frame. Additional electronic components not explicitly shown can include an audio output device (e.g., one or more speakers), an illumination device, and so forth. The battery 118 can be, for example, a lithium-ion rechargeable battery for energizing some or all of the electronic components. In some implementations, the image sensors 116 can include a world-facing camera, or an egocentric camera, and/or an inward facing image sensor/camera such as a gaze tracking device. In some examples, the sensing system 114 may include a near infrared (NIR) sensor. The control system 112 may include various control system devices including, for example, one or more processors e.g., central processing units (CPUs) and/or one or more graphics processing units (GPUS), operably coupled to other components of the control system 112.

In some examples, the control system 112 may further include a communication module, e.g., an RF headset transceiver, providing for communication and exchange of information between the head-mounted wearable display 100 and other external devices. In some implementations, the transceiver includes a receiver and a transmitter configured to operate in different bands, or frequency ranges, depending on the type or location of the external devices. For example, the head-mounted wearable display 100 may communicate with an external device using short-range signals, e.g., Bluetooth™ and with the server computing system 500 using longer-range RF signals such as WiFi or 4G/5G. In some implementations, the RF headset transceiver communicates signals to and from an external microprocessor. In some implementations, the RF headset transceiver communicates signals on multiple channels.

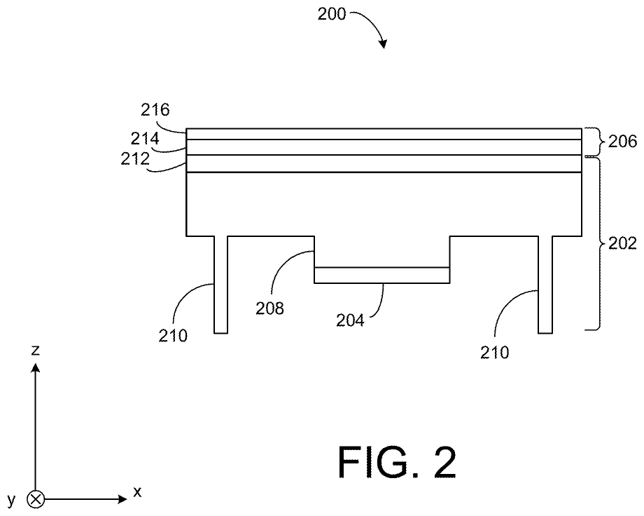

FIG. 2 is a cross-sectional view of the transparent cover window 200 illustrating various layers thereof. In some implementations, the transparent cover window 200 includes a base 202, a film-in-mold 204, and a multi-layer external surface 206. The base 202 can be made of a molded plastic material. In some examples, the base 202 includes a central trench 208. In some implementations, the film-in-mold 204 can be deposited into the central trench 208 after the base 202 is formed. In some implementations, the film-in-mold 204 can be formed simultaneously with the base 202 using a film insert molding (FIM) process. The base 202 may further include internal mounting features 210, e.g., mounting pins, molded therein. In some implementations, the multi-layer external surface 206 includes a three-layer stack: a hard coating 212 on the bottom, an anti-reflective (AR) coating 214 in the middle, and an anti-smudge (AS) coating 216 on top. The various coatings can be configured to reduce transmission of NIR wavelengths of light to an underlying light sensor or camera.

In some implementations, the transparent cover window 200 has a total thickness of about 1 mm, measured from the bottom of the film-in-mold 204 to the top of the AS coating 216. In some implementations, the hard coating 212 has a thickness in a range of about 3 μm to about 20 μm. The hard coating 212 hardens the surface of the molded plastic to improve scratch resistance and makes the plastic surface more like a glass surface. While glass would be preferable for its optical properties, plastic is preferable for safety reasons. In some implementations, the AR material can be a multi-layer coating in which the multiple layers have alternating indices of refraction. The AR coating 214 can have a total thickness between about 0.5 μm to about 1.5 μm, wherein each layer of the AR coating can have a thickness between about 15 nm and about 250 nm. The AR coating serves to reduce reflections of light back to the camera or sensor. The AS coating 216 can have a thickness in a range of about 18 nm to about 22 nm. In some implementations, the film-in-mold 204 can also be a multi-layer stack having a total thickness in a range of about 0.27 mm to about 0.33 mm. For example, the film-in-mold 204 can be a commercial product having constituent layers of polycarbonate (PC) material and PMMA material.

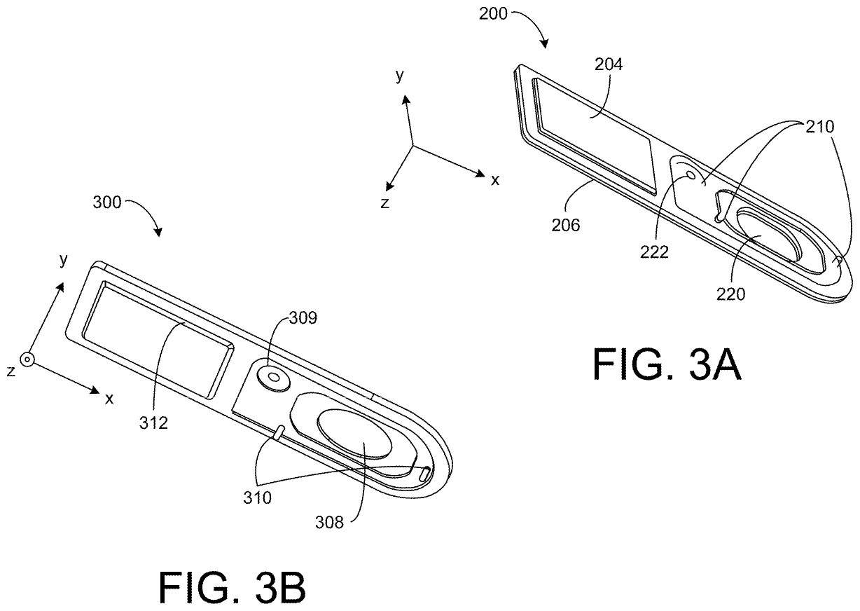

FIGS. 3A and 3B illustrate use of the transparent cover window 200, according to some implementations of the present disclosure. The transparent cover window 200 can be used to protect a NIR sensor of the sensing system 114. FIG. 3A shows a top perspective view of the transparent cover window 200 shown in FIG. 2. FIG. 3B shows an apparatus 300 that the transparent cover window 200 fits over. In some implementations, the apparatus 300 includes features such as, for example, a control button 308, a microphone 309, a mounting pin 310, and contours 312.

In some implementations, the multi-layer external surface 206 of the transparent cover window 200 features a large opening 220, and a small opening 222 that are not evident in the cross-sectional view shown in FIG. 2. The large opening 220 in the multi-layer external surface 206 allows the control button 308 to extend through the multi-layer external surface 206 for access by a user. The control button 308 can be, for example, an on-off switch for activating an NIR sensor or an image sensor. Alternatively, the control button 308 can be a user-controlled switch for activating or re-positioning the transparent cover window 200. The small opening 222 can accommodate, for example, the microphone 309. In some implementations, the width of the transparent cover window 200 is in a range of about 10 mm to about 12 mm and the length of the transparent cover window 200 is about 35 mm.

The molding technique used to form the transparent cover window 200 allows the transparent cover window 200 to have raised features on internal surfaces so as to support accurate placement of components and ease of assembly with high precision. Internal optical surfaces such as the contours 312 shown in FIG. 3B, are made with film-in-mold (FIM) technology; this allows high-yield and low-risk implementation of optical tolerances for the internal surfaces of the transparent cover window 200 and the underlying apparatus 300.

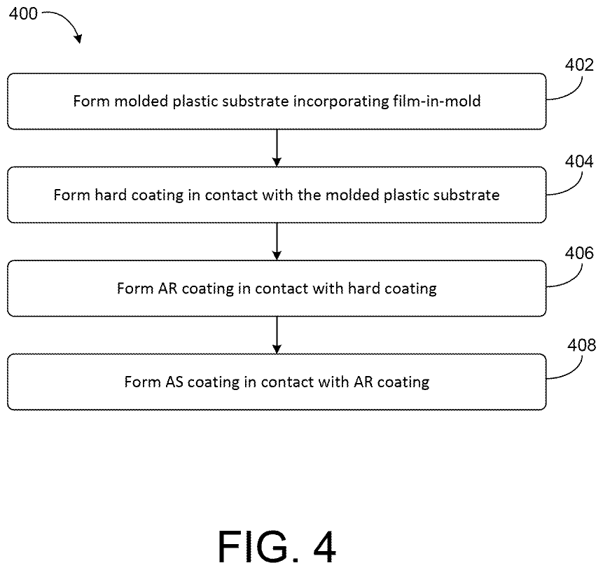

FIG. 4 is a flow chart illustrating a method 400 of forming the transparent cover window 200 for use in protecting a near infrared sensing device, according to some implementations of the present disclosure. Operations of the method 400 can be performed in a different order, or not performed, depending on specific applications. It is noted that the method 400 may not produce a complete transparent cover window. Accordingly, it is understood that additional processes can be provided before, during, or after the method 400, and that some of these additional processes may be briefly described herein. The operations 402-408 can be carried out to form the transparent cover window 200 according to the implementations described above, with reference to the cross-section shown in FIG. 2. In some implementations, the method 400 can improve manufacturing yields over previous methods.

At 402, the method 400 includes forming a molded plastic substrate, e.g., the base 202 including the film-in-mold 204, according to some implementations of the present disclosure. A process of injection molding can be used to form the base 202. Plastic is a safe choice for placement of material near the human eye, compared to materials like glass. In some implementations, the molded plastic substrate can be formed so as to include a depression, e.g., the central trench 208 as shown in FIG. 2. In some implementations, a film insert molding (FIM) process can be used to form the base 202 along with the film-in-mold-204 in the same process step. The film-in-mold 204 can be centered on a surface of the base material, for incorporation into the base 202 in a subsequent injection molding procedure.

Alternatively, in some implementations, the method 400 includes, at 402, forming the base 202 by injection molding, and then masking the molded plastic substrate to expose a portion thereof, e.g., the central trench 208, according to some implementations of the present disclosure. A photoresist mask, or a contact mask, or another masking process can be used to selectively cover portions of the base 202. Then, the method 400 includes depositing a film, e.g., the film-in-mold 204, onto the exposed portion of the molded plastic base 202, The deposition may fill part or all of the central trench 208. In some implementations, the deposition can be carried out using a plasma vapor deposition (PVD) process. The deposition may be a multi-step deposition to create a multi-layer film-in-mold 204.

At 404, the method 400 includes, after the molding process is complete, forming a hard coating, e.g., the hard coating 212, in contact with the molded plastic substrate, according to some implementations of the present disclosure. In some implementations, the mask can remain in place while the deposition of the coatings occurs, so that the coatings are not deposited onto an uneven surface.

In some implementations, it may be possible to use a double-sided FIM process for both the film-in-mold 204 and the hard coating 212. However, for the implementation described herein, the desired film thicknesses would constrain the thickness of the molded plastic substrate, which could degrade the mechanical stability and shape of the product and possibly also the external surface quality. For at least this reason, a FIM process is only used to incorporate the film-in-mold 204.

At 406, the method 400 includes forming the anti-reflective (AR) coating 214 in contact with the hard coating 212, according to some implementations of the present disclosure.

At 408, the method 400 includes forming the anti-smudge (AS) coating 216 in contact with the AR coating 214, according to some implementations of the present disclosure.

Forming the stack of coatings including the hard coating 212, the AR coating 214, and the AS coating 216 may be carried out in a multi-step deposition procedure that occurs sequentially in a same vacuum chamber of a deposition platform, e.g., a PVD tool.

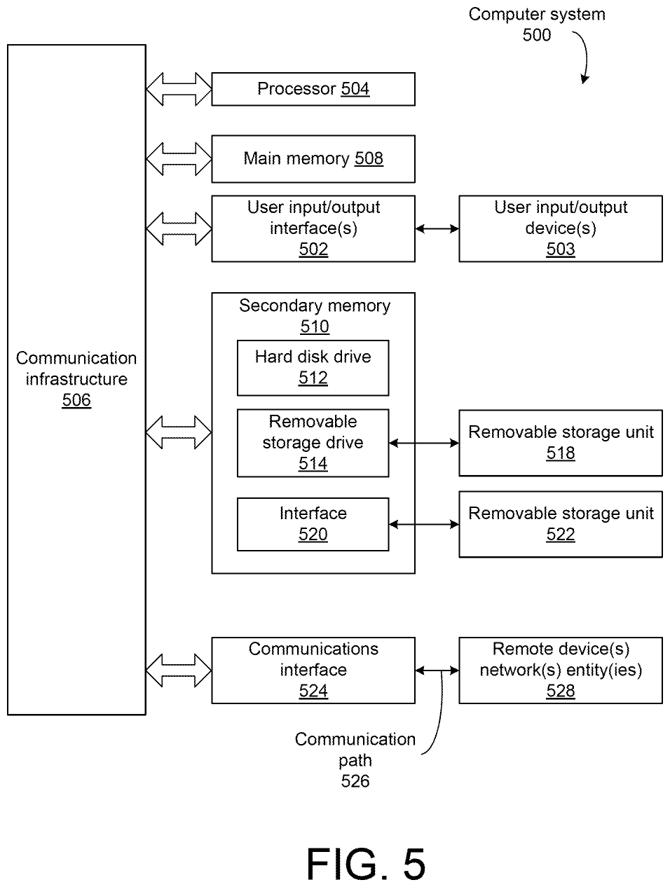

FIG. 5 is an illustration of an example computer system 500 in which various embodiments of the present disclosure can be implemented. The computer system 500 can be any well-known computer capable of performing the functions and operations described herein. For example, and without limitation, the computer system 500 can provide a hardware platform for processing sensory and image data communicated from the devices described above that are mounted to the AR glasses.

The computer system 500 includes one or more processors (also called central processing units, or CPUs), such as a processor 504. The processor 504 is connected to a communication infrastructure or bus 506. The computer system 500 also includes input/output device(s) 503, such as monitors, keyboards, pointing devices, etc., that communicate with a communication infrastructure or bus 506 through input/output interface(s) 502. The processor 504 can receive instructions to implement functions and operations described herein via input/output device(s) 503. The computer system 500 also includes a main or primary memory 508, such as random access memory (RAM). The main memory 508 can include one or more levels of cache. The main memory 508 has stored therein control logic (e.g., computer software) and/or data.

The computer system 500 can also include one or more secondary storage devices or secondary memory 510. The secondary memory 510 can include, for example, a hard disk drive 512 and/or a removable storage device or drive 514. The removable storage drive 514 can be a floppy disk drive, a magnetic tape drive, a compact disk drive, an optical storage device, tape backup device, and/or any other storage device/drive.

The removable storage drive 514 can interact with a removable storage unit 518. The removable storage unit 518 includes a computer usable or readable storage device having stored thereon computer software (control logic) and/or data. The removable storage unit 518 can be a floppy disk, magnetic tape, compact disk, DVD, optical storage disk, and/any other computer data storage device. The removable storage drive 514 reads from and/or writes to removable storage unit 518 in a well-known manner.

According to some embodiments, the secondary memory 510 can include other means, instrumentalities or other approaches for allowing computer programs and/or other instructions and/or data to be accessed by the computer system 500. Such means, instrumentalities or other approaches can include, for example, a removable storage unit 522 and an interface 520. Examples of the removable storage unit 522 and the interface 520 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 500 can further include a communication or network interface 524. The communication interface 524 enables the computer system 500 to communicate and interact with any combination of remote devices, remote networks, remote entities, etc. (individually and collectively referenced by remote devices 528). For example, the communication interface 524 can allow the computer system 500 to communicate with the remote devices 528 over communications path 526, which can be wired and/or wireless, and which can include any combination of LANs, WANs, the Internet, etc. Control logic and/or data can be transmitted to and from the computer system 500 via the communication path 526.

The operations in the preceding embodiments can be implemented in a wide variety of configurations and architectures. Therefore, some or all of the operations in the preceding embodiments can be performed in hardware, in software or both. In some embodiments, a tangible apparatus or article of manufacture comprising a tangible computer useable or readable medium having control logic (software) stored thereon is also referred to herein as a computer program product or program storage device. This includes, but is not limited to, the computer system 500, the main memory 508, the secondary memory 510 and the removable storage units 518 and 522, as well as tangible articles of manufacture embodying any combination of the foregoing. Such control logic, when executed by one or more data processing devices (such as the computer system 500), causes such data processing devices to operate as described herein.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Some implementations may be implemented using various semiconductor processing and/or packaging techniques. Some implementations may be implemented using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method, comprising:
forming a molded plastic substrate having a film-in-mold layer on an internal surface thereof; and
forming a stack of coatings on a portion of an external surface of the molded plastic substrate, the stack of coatings including at least one of a hard coating, an anti-reflective (AR) coating, or an anti-smudge (AS) coating.

2. The method of claim 1, wherein forming the molded plastic substrate comprises forming the molded plastic substrate using an injection molding process.

3. The method of claim 1, wherein forming the stack of coatings comprises forming at least one coating using a plasma vapor deposition (PVD) process.

4. The method of claim 1, wherein forming the stack of coatings comprises forming a hard coating in contact with the molded plastic substrate.

5. The method of claim 4, wherein forming the stack of coatings comprises forming an AR coating in contact with the hard coating.

6. The method of claim 5, wherein forming the stack of coatings comprises forming an AS coating in contact with the AR coating.

7. The method of claim 1, wherein forming the stack of coatings comprises forming multiple coatings in a multi-step deposition procedure that occurs sequentially in a same vacuum chamber.

8. The method of claim 1, wherein forming the stack of coatings comprises masking a remainder of the external surface to expose the portion of the external surface.

9. An apparatus, comprising:
a molded plastic substrate having a first surface and a second surface;
a molding film attached to the first surface of the molded plastic substrate; and
a stack of coatings formed on the second surface, the stack of coatings including:
a hard coating in contact with the second surface of the molded plastic substrate;
an AR coating in contact with the hard coating; and
an AS coating in contact with the AR coating.

10. The apparatus of claim 9, wherein the molded plastic substrate is made of polycarbonate.

11. The apparatus of claim 9, wherein the AR coating is a multi-layer coating in which adjacent layers have alternating indices of refraction.

12. The apparatus of claim 9, wherein the molding film includes at least one of polycarbonate or PMMA.

13. The apparatus of claim 9, wherein the stack of coatings has a total thickness in a range of about 0.5 mm to about 1.0 mm.

14. An apparatus comprising:
a lens;
a frame surrounding the lens;
a light sensor mounted to the frame;
a multi-layer cover over the light sensor; and
a user-controlled switch configured to activate the multi-layer cover.

15. The apparatus of claim 14, configured for use as augmented reality glasses.

16. The apparatus of claim 14, wherein the eyewear is configured for use as virtual reality goggles.

17. The apparatus of claim 14, wherein the light sensor is a camera.

18. The apparatus of claim 17, wherein the camera is at least one of an eye-tracking camera, a world facing camera, a hand-tracking camera, or a night vision camera.

19. The apparatus of claim 14, wherein the multi-layer cover includes coatings configured to reduce transmission of near infrared wavelengths of light to the light sensor.

20. The apparatus of claim 14, wherein the multi-layer cover includes a molded plastic substrate having internal mounting features.
